(19) United States
(12) Patent Application Publication
(10) Pub. No.: US 2008/0013552 A1
(43) Pub. Date: Jan. 17, 2008

(54) Methods, systems and computer program products for communication load routing at a user location

(76) Inventors: Steven Allan Wright, Roswell, GA (US); Steven Tischer, Atlanta, GA (US)

Correspondence Address: MYERS BIGEL SIBLEY & SAJOVEC, P.A., P.O. BOX 37428, RALEIGH, NC, 27627, US

(21) Appl. No.: 11/485,492

(22) Filed: Jul. 12, 2006

(51) Int. Cl. H04L 12/56

(52) U.S. Cl. 370/401; 370/392

(57) ABSTRACT

Methods, systems and computer program products for load routing across a plurality of networks are provided. A request to exchange communication data between a user endpoint device and a target device is received. At an application layer, a first portion of the communication data associated with the request is allocated for routing over a first network domain and a second portion of the communication data associated with the request is allocated for routing over a second network domain, administered independently from the first network domain, to provide an allocation of the communication data. The first portion is routed between the user endpoint device and the target device over a network access link coupled to the first network domain without notifying the first network domain of the allocation of the communication data. The second portion is routed between the user endpoint device and the target device over a network access link coupled to the second network domain without notifying the second network domain of the allocation of the communication data.

### BACKGROUND

The present invention generally relates to the field of data communications and, more particularly, to data routing.

It is common to connect a plurality of systems and devices through a communication medium often referred to as a network. Such networks among communicating devices permit devices (or users of devices) to easily exchange and share information among the various devices. The Internet is a presently popular example of such networking on a global scale. Individual users attach their devices to the Internet, thereby enabling sharing of vast quantities of data on other devices geographically dispersed throughout the world.

Networked computing systems may be configured and graphically depicted in a wide variety of common wired and/or wireless topologies. In other words, the particular configurations of network communication links (also referred to as paths) and devices (e.g. routers, switches) between a particular pair of endpoint node devices wishing to exchange information may be widely varied. Any particular connection between two endpoint node computers attached to a network may be direct or may pass through a large number of intermediate devices in the network. In addition, there may be a plurality of alternative paths through the network connecting any two network devices. Different groupings of the devices and paths may be administered by different network administrators. Each administrator may establish one or more domains grouping the devices and links of the network they administer.

Most present network communication media and protocols are referred to as packet oriented. A protocol or communication medium may be said to be packet oriented in that information to be exchanged over the network is broken into discrete sized packets of information. A block of information to be transferred over the network is decomposed into one or more packets for purposes of transmission over the network. At the receiving end of the network transmission, the packets are re-assembled into the original block of data.

In general, each packet includes embedded control and addressing information that identifies the source device which originated the transmission of the packet and which identifies the destination device to which the packet is transmitted. Identification of source and destination devices is by means of an address associated with each device. An address is an identifier that is unique within the particular computing network to identify each device associated with the network. Such addresses may be unique to only a particular network environment (i.e., a network used to interconnect a single, self-contained computing environment) or may be generated and assigned to devices so as to be globally unique in co-operation with networking standards organizations.

A variety of different protocol layers are provided in various packet communication protocols, such as TCP/IP. At the lowest level of network communication, the addresses in packets may be often referred to as MAC address (Media ACcess address). Network protocol layers above this lower layer of communication protocol may use other addresses for other purposes in the higher layer. In most network low level communication levels, operable on the physical link medium, an address is referred to as a MAC address, while higher layers may use an assigned internet protocol (IP) address associated with the device MAC address.

In many present commercially available network environments, the network communication medium is in essence a bus commonly attached to a plurality of devices over which the devices exchange communications. In a simple networking topology, all devices may be attached to a such a bus structured common network medium. Any particular single network medium generally has a maximum data exchange bandwidth associated therewith. The maximum data exchange bandwidth of a medium may be determined by a number of electrical and physical properties of the medium and protocols used to communicate over that medium. For example, a popular family of related network media and protocols are collectively referred to as Ethernet. Ethernet defines a standard protocol for the exchange of messages over the communication medium. A variety of communication media are also defined as part of the Ethernet family. The communication bandwidth of the Ethernet family of standards presently range from approximately 10 Mbit (million bits of information) per second to 1 Gbit per second. Therefore, a single (slow) Ethernet connection, for example, may have maximum data exchange bandwidth of approximately 10 Mbit per second. As such, where multiple such bandwidth limited connections (links) are available, it may be desirable to provide load balancing.

In present network environments, a number of devices are typically used in addition to interconnected computing systems to efficiently transfer data over the network. Routers and switches are network devices that may segregate information flows over various segments of a computer network. Protocols are provided and supported by many of such devices to improve routing and utilization of bandwidth on such networks. For example, the Equal Cost Multipath Protocol (ECMP) may be used by network administrators to improve routing over a network or networks providing multiple paths between pairs of endpoint nodes.

### SUMMARY

Embodiments of the present invention include methods of load routing across a plurality of networks. A request to exchange communication data between a user endpoint device and a target device is received. At an application layer, a first portion of the communication data associated with the request is allocated for routing over a first network domain and a second portion of the communication data associated with the request is allocated for routing over a second network domain, administered independently from the first network domain, to provide an allocation of the communication data. The first portion is routed between the user endpoint device and the target device over a network access link coupled to the first network domain without notifying the first network domain of the allocation of the communication data. The second portion is routed between the user endpoint device and the target device over a network access link coupled to the second network domain without notifying the second network domain of the allocation of the communication data. The network access link coupled to the first network domain and the network access link coupled to the second network domain may be different link types, such as a cable link type and/or a digital subscriber line (DSL) link type.

In further embodiments, the communication data is data from the target device to be routed to the user endpoint device and routing the first portion and routing the second portion include arranging, at the application layer, the first portion and the second portion to provide a single communication data flow and providing the single data communication flow to the user endpoint device. Receiving the request may include receiving communication data from the user endpoint device addressed to the target device that requests responsive communication data from the target device. Routing the first portion and routing the second portion may include generating a first request for the first portion of the communication data and forwarding the first request to the target device on the network access link coupled to the first network domain and generating a second request for the second portion of the communication data and forwarding the second request to the target device on the network access link coupled to the second network domain.

In other embodiments, the target device has an associated internet protocol (IP) address and generating the first request includes setting the IP address of the target device as a destination address and a first IP address as a sender address for the first request. Generating the second request includes setting the IP address of the target device as a destination address and a second IP address, different from the first IP address, as a sender address for the second request. Providing the single data communication flow to the user endpoint device includes setting an IP address of the user endpoint device as a destination address and a third IP address as a sender address for the single data communication flow. The third IP address may be the first IP address or the second IP address.

In further embodiments receiving a request, allocating at an application layer, routing the first portion, routing the second portion, assembling the first portion and providing the single data flow are performed by a communication load routing system located at a user location including the user endpoint device. The communication load routing system includes a first network interface to the network access link coupled to the first network domain and a second network interface to the network access link coupled to the second network domain.

In yet further embodiments, receiving a request, allocating at an application layer, routing the first portion, routing the second portion, assembling the first portion and providing the single data flow are performed by a first communication load routing system coupled to the user endpoint device and located at a user location including the user endpoint device. The first communication load routing system includes a wide area network interface to the network access link coupled to the first network domain and a local network interface communicatively coupled to a second communication load routing system having a wide area network interface to the network access link coupled to the second network domain. Generating the first request is performed by the first communication load routing system and generating the second request is performed by the second communication load routing system. Routing the second portion includes the following carried out by the first communication load routing system: requesting generation of the second request by the second communication load routing system; and receiving the second portion from the second communication load routing system. A second user endpoint device may be coupled to the second communication load routing system and allocating at an application layer may include allocating at an application layer a first portion of communication data for routing between the second user endpoint device and a second target device over the first network domain and a second portion of the communication data for routing between the second user endpoint device and the second target device over the second network domain.

In other embodiments, allocating at an application layer includes selecting the first portion and the second portion to increase a security level associated with the transmission of the communication data. Allocating at an application layer may include selecting the first portion and the second portion based on a cost associated with the transmission of the communication data over the first network domain and over the second network domain. The first network domain may have an associated internet protocol version different from an associated internet protocol version of the second network domain. Allocating at an application layer may include establishing a bartering session between a provider of the first network domain and a provider of the second network domain for communication of the communication data and allocating the first portion and the second portion based on the bartering session.

Other embodiments further aggregating a charge for use of the first network domain by the user endpoint device and a charge for use of the second network domain by the user endpoint device. The aggregated charge is provided to a user of the user endpoint device. Receiving a request may include receiving a plurality of requests and at least one of the plurality of requests may be associated with communication data that is all routed over the first network domain or the second network domain. Each of the plurality of requests may be associated with data and allocating at an application layer may include allocating a different percentage of the associated data to the first portion and the second portion for different ones of the plurality of requests.

In yet other embodiments, a communication load routing system for a user location includes a network interface to a first network having an associated first network domain and a network interface to a second network having an associated second network domain that is administered independently from the first network domain. The system further includes an endpoint node interface is coupled to a user endpoint device at the user location and a processor. The processor is configured to allocate routing of communication data to be exchanged between the user endpoint device and a target device across both the first network domain and the second network domain at an application layer without notifying the first or second network domain of the allocation of the communication data.

In further embodiments, the processor is configured to associate a first internet protocol (IP) address with a portion of the communication data allocated to the first network domain and a second IP address with the communication data allocated to the second network domain and to associate a third IP address to the user endpoint device. The processor is further configured to arrange communication data received from both the first and the second network domain as a single data stream to the user endpoint device at the application layer. The processor may be further configured to receive communication data from the user endpoint device addressed to the target device that requests responsive communication data from the target device, to generate a first request for the first portion of the communication data and forward the first request to the target device on the network interface coupled to the first network and to generate a second request for the second portion of the communication data and forward the second request to the target device on the network interface coupled to the second network.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE FIGURES

FIG. 1 is a block diagram of a communication system according to some embodiments of the present invention.

FIG. 2 is a block diagram of a data processing system suitable for use as a communication load routing system in some embodiments of the present invention.

FIGS. 3-4 are flowcharts illustrating operations for load routing across a plurality of networks according to some embodiments of the present invention.

### DETAILED DESCRIPTION OF EMBODIMENTS OF THE INVENTION

The present invention now will be described more fully hereinafter with reference to the accompanying figures, in which embodiments of the invention are shown. This invention may, however, be embodied in many alternate forms and should not be construed as limited to the embodiments set forth herein. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein the term “and/or” includes any and all combinations of one or more of the associated listed items.

It will be understood that, when an element is referred to as being “coupled” to another element, it can be directly coupled to the other element or intervening elements may be present. In contrast, when an element is referred to as being “directly coupled” to another element, there are no intervening elements present.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present specification and will not be interpreted in an idealized or overly formal sense unless expressly so defined herein.

The present invention may be embodied as methods, systems, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. Note that references to a computer herein include any network attachable device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention is described below with reference to block diagrams and/or flowchart illustrations of methods, apparatus, and computer program products according to embodiments of the invention. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

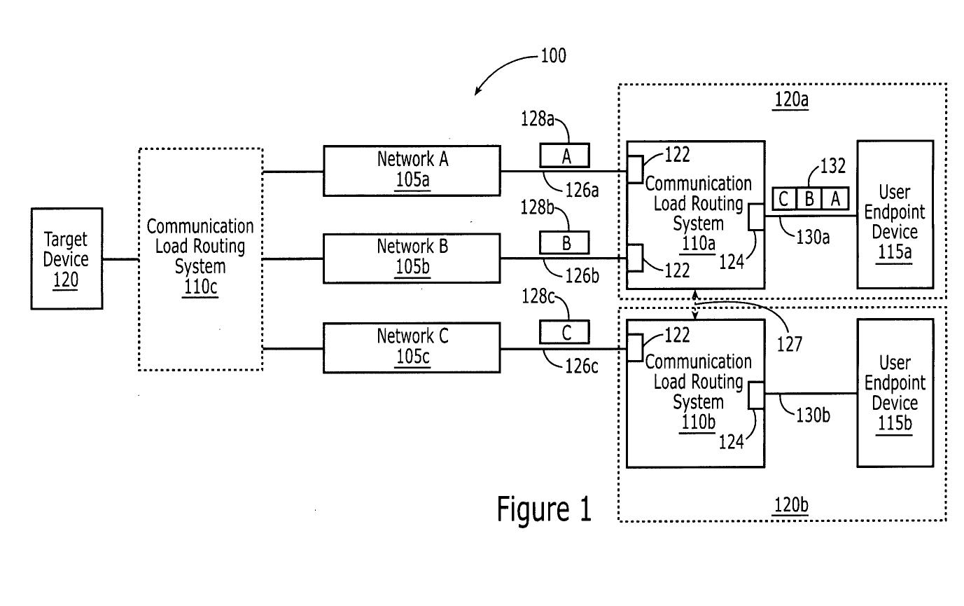

Some embodiments of the present invention will now be described with reference to the block diagram illustration of FIG. 1. As shown in the embodiments of FIG. 1, a communication system 100 includes a plurality of networks 105a, 105b, 105c and communication load routing systems 110a, 110b, 110c that communicatively couple user endpoint devices 115a, 115b and a target device 120. While only a single target device 120 is illustrated in FIG. 1, it will be understood that a large number of target devices may be coupled to the user endpoint devices 115a, 115b over the networks 105a, 105b, 105c. Similarly, while only two user endpoint devices 115a, 115b are shown in FIG. 1, a large number of such endpoint devices may be coupled to the networks 105a, 105b, 105c and while only three networks 105a, 105b, 105c are shown in FIG. 1, a lesser and/or greater number of networks may be utilized. In addition, while a communications load routing system 110c is shown coupled to the target device 120, no communication load routing system is provided on the target device end of a communication connection in some embodiments of the present invention. Finally, while network A 105a, network B 105b and network C 105c are shown as distinct segregated network blocks in FIG. 1, it will be understood that each of the networks generally will include a plurality of different interconnecting devices, such as routers and/or switches, and links connecting such interconnecting devices and that different ones of the networks may, in practice, in routing different communications, utilize links or interconnecting devices of others of the networks in routing packets or other communication data between endpoint devices and target devices utilizing, for example, data exchange protocols and the like associated with the World Wide Web and the Internet protocol (IP). Similarly, while separate links are shown between the communication mode routing system 110c and each of the networks 105a, 105b, 105c, the last link to the communication load routing system 110c may be a single physical link shared by all the networks and/or a plurality of separate links, each of which may be shared by various of the networks or associated with a specific one of the networks.

While the networks 105a, 105b, 105c may be more physically interrelated than is shown schematically in FIG. 1, it will be understood that, as used herein, each of the networks is separately administered. More particularly, each of the networks 105a, 105b, 105c includes one or more network domains administered by a respective network administrator independently of others of the networks. Furthermore, while load routing across the networks 105a, 105b, 105c will be described with reference to the communication load routing systems 110a, 110b, it will be understood that in some embodiments of the present invention, load routing for balancing purposes or the like may also be provided by the networks 105a, 105b, 105c. For example, the networks 105a, 105b, 105c may be configured to support the Equal Cost Multi-Path protocol (ECMP) procedures for load balancing across the networks, which load balancing is generally performed at layers below the application layer. In contrast, as will be described herein with reference to the communication load routing system(s) 110a, 110b, load routing may be provided across the networks 105a, 105b, 105c at an application layer, which load routing may be transparent to the user endpoint devices 115a, 115b and may be provided without notifying the respective network domains of the networks 105a, 105b, 105c of the allocation of communication data over different networks by the communication load routing system(s) 110a, 110b. However, it will be understood that, in some embodiments, the user endpoint devices 115a, 115b may be aware of the communication load routing systems 110a, 110b and may be able to provide user preference input to the respective communication load routing systems 110a, 110b to affect the load routing operations of the respective systems 110a, 110b.

As further shown in the embodiments of FIG. 1, the communication load routing system 110a includes a network interface 122 to network A 105a. In addition, the communication load routing system 110a includes a second network interface 122 to network B 105b. An endpoint node interface 124 of the communication load routing system 110a is coupled to the user endpoint device 115a. The communication load routing system 110a and the user endpoint device 115a are shown as both being located at a user location 120a, such as a residence of a user of the user endpoint device 115a or the like.

The communication load routing system 110a is shown as coupled through the endpoint node interface 124 to the user endpoint device 115a by a communication link 130a. The first network interface 122 of the communication load routing system 110a is illustrated connected to network A 105a by a network access link 126a coupled to network A 105a. A second network access link 126b couples the communication load routing system 110a to network B 105b.

Similarly, the communication load routing system 110b is shown as including a network interface 122 coupling the communication load routing system 110b to network C 105c by a network access link 126c. In addition, the communication load routing system 110c is shown as including an endpoint node interface 124 coupled to the user endpoint device 115b by a link 130b. The communication load routing system 110b and the user endpoint device 115b are shown as both being located at a user location 120b such as a residence of a user of the user endpoint device 115b.

The network access links 126a, 126b, 126c may be different link types. For example, the links 126a, 126b, 126 may be a cable link type, a digital subscriber line (DSL) link type and so on. By way of further example, in a residential context, the link 126a, may be, for example, a Bellsouth DSL connection at a bandwidth of 2 Megabits per second while the link 126 may be a Comcast cable high speed connection having a bandwidth of 6 Megabits per second. However, these particular link types and their associated bandwidths and network service provider are provided herein simply by way of illustrative example.

Also illustrated schematically in FIG. 1 is communication data 132 to be exchanged between the user endpoint device 115a and the target device 120. A first portion 128a of the communication data 132 is shown carried on the first link 126a over network A 105a. A second portion 128b is shown on the second link 126b and a third portion 128c is shown on the third link 126c. It will be understood that the illustrated portions 128a, 128b, 128c and the corresponding communication data 132, which is shown as a single communication data flow in FIG. 1, may represent communication data from the user endpoint device 115 to the target device 120 or from the target device 120 to the user endpoint device 115a. The first portion 128a may be routed over a first network domain administered by the administrator of network A 105a. The second portion 128b may be routed over a second network domain independently administered by an administrator of network B 105b. The third portion 128c may similarly be routed over a third network domain independently administered by the administrator of network C 105c.

Access to network C 105c for the communication load routing system 110a may be through the communication load routing system 110b via a communication link 127 schematically illustrated in FIG. 1. The link 127 may be, for example, a local wireless and/or wired network connection between the respective communication load routing systems 110a, 110b. The link 127 may, in some embodiments, utilize a wired and/or wireless connection, which wired and/or wireless connection may be between the respective user endpoint devices 115a, 115b and/or routers, hubs or the like connecting the respective user endpoint devices 115a, 115b, in which instance the user endpoint devices 115a, 115b may themselves provide nodes in support of the communication link 127 between the respective communication load routing systems 110a, 110b illustrated in FIG. 1. Furthermore, the communication load routing system 110b in some embodiments may not be a separate device as shown in FIG. 1, but may be implemented in software or the like in the user endpoint device 115b while still providing access to network C 105c for use in allocating portions of communications data to network C 105c during load routing operations by the communication load routing system 110a.

Each of the portions 128a, 128b, 128c may correspond to one or a plurality of packets of communication data. Furthermore, references to communication data herein are to be interpreted broadly as including any digitally represented information included in a payload portion of a communication over the networks 105a, 105b, 105c including voice, data and the like, either encoded or uncoded.

By way of illustration of an exemplary load routing, the user endpoint device 115b may request access to a website, such as cnn.com, which may be supported by a server as the target device 120. The requested website may begin downloading normally but there may be 50 separate subordinate files on the site to be downloaded responsive to the request from the user endpoint device 115b. The communication load routing system 110b may request, via the communication load routing system 110a several of the subordinate files to be downloaded separately. Communication load routing system 110a may then separately connect to cnn.com (target device 120) via network A 105a and/or network B 105b to retrieve the requested components while further components continue to be downloaded over network C 105c through communications mode routing system 110b. Thus, a request from the user endpoint device 115b having an associated plurality of communication data to be downloaded from a target device 120 may be converted into a plurality of individual requests.

By way of further example for data flow from the user endpoint device 115a, 115b to the target device 120, large medical files or the like may be uploaded from the user endpoint device 115a, 115b to the target device 120. In this regard, reliability or security issues may dictate the desirability of allocating different portions of the load across different networks. Thus, the communication data 132 may be a large medical record file, portions 128a, 128b, 128c of which are separately routed over network A 105a, network B 105b, and network C 105c.

It will be understood that load routing across a plurality of networks in accordance with some embodiments of the present invention may allow for cost prioritization and for billing aggregation across networks. Micro-billing may be provided from each network and bartering for service value among different users and/or networks may further be provided. In addition, distributed security may be increased through the distribution of communication data associated with a request across a plurality of networks. In addition, a higher reliability of communications may be provided as the loss of a single network connection may be overcome by shifting further traffic to other available network connections. In addition, version compatibility may be provided in some embodiments where respective networks have differing protocol versions, which distinct versions may all be supported by a communication mode routing system 110a, 110b transparently to the version of communication protocol supported and used by the respective endpoint devices 115a, 115b. It will further be understood that, in some embodiments of the present invention, the respective communication load routing system 110a, 110b and its corresponding user endpoint device 115a, 115 may be both implemented in a single computer and, for example, the user endpoint device 115a, 115b illustrated in FIG. 1 may be a browser application executing on a computer that is also configured to carry out the load routing operations described herein with respective to the communication load routing system(s) 110a, 110b. Such a computer may then include a plurality of network interfaces 122 separately connected to the different networks through different physical network access links 126a, 126b, 126c or the like.

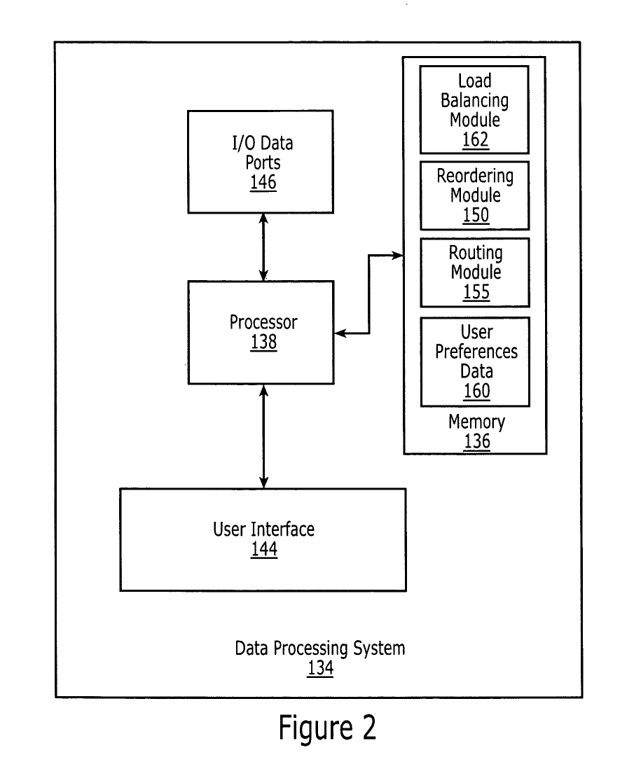

Referring now to FIG. 2, an exemplary embodiment of devices, for example, a personal computer system or the like or other data processing system 134, configured as a communication load routing system 110a, 110b, 110c in accordance with some embodiments of the present invention will be discussed. The data processing system 134, which may be incorporated in, for example, a personal computer, a PDA, a wireless terminal/phone, or the like, may include a user interface 144, including, for example, input device(s) such as a keyboard or keypad, a display, a speaker and/or microphone, and a memory 136 that communicate with a processor 138. The data processing system 134 may further include an I/O data port(s) 146 that also communicates with the processor 138. The I/O data ports 146 can be used to transfer information between the data processing system 134 and another computer system or networks that may be associated with a communications service provider or user communication devices using, for example, an Internet Protocol (IP) connection. These components may be conventional components such as those used in many conventional data processing systems, which may be configured to operate as described herein. Thus, the I/O data ports 146 may include the network interfaces 122 and/or the endpoint node interfaces 124.

As shown in the embodiments of FIG. 2, the memory 136 includes a load balancing module 162, a reordering module 150, a routing module 155 and user preferences data 160. Each of the modules 162, 150, 155 stored in the memory 136 may be executed by the processor 138 and may use the user preference data 160, which is also available to the processor 138.

The load balancing module 162 may configure the processor 138 to allocate routing of communication data to be exchanged between a user endpoint device 115a, 115b and a target device 120 across both a first network domain of a first network and a second network domain of a second network. It will be understood that, while two network domains across two networks are used in this description, load balancing may on different occasions use more than two networks or a single network for a particular communication data load associated with a request.

The routing module 155, in some embodiments, may configure the processor 138 to route a first portion of the communication data allocated by the load balancing module 162 over a first network domain and a second portion over a second network domain. The routing module 155 may configure the processor 138 to route the respective portions across the first and second network domains with notifying the first or second network domain of the allocation of the communication data. In other words, unlike ECMP, the load balancing may be performed at a higher protocol layer without notification to the respective network administrators.

The routing module 155 may configure the processor 138 to associate a first internet protocol address with a portion of a communication data allocated to the first network domain and a second IP address with the communication data allocated to the second network domain. A third IP address may be associated with the user endpoint device. The reordering module 150 may configure the processor 138 to arrange or assemble communication data received from both the first and the second network domain as a single data stream to the user endpoint device at the application layer.

In some embodiments, the routing module 155 may further configure the processor 138 to receive communication data from the user endpoint device addressed to the target device that requests responsive communication data from the target device and to generate a first request for the first portion of the communication data and forward the first request to the target device on the network interface coupled to the first network and to generate a second request for the second portion of the communication data and forward the second request to the target device on the network interface coupled to the second network.

The user preferences data 160 may include addressing and configuration information identifying protocols, drivers and/or the like for communications through respective interfaces 122, 124 and/or protocols for such communications supported by the respected networks 105a, 105b, 105c and devices 115a, 115b, 120. The user preferences data 160 may also include user designated parameters for load balancing and the like. For example, a user may input preferences related to communication bandwidth, costs or other preferential ordering or network selection. Such user preferences data may be input through the user interface 144 or through the I/O data port 146 in various embodiments.

While shown as resident in the memory 136 in the embodiments of FIG. 2 it will be understood that the respective database and module features, including the load balancing module 162, the reordering module 150 and/or the routing module 155 may be implemented, for example, as part of the operating system, as application programs, as components of a dynamic link library or the like of the data processing system 130 so as to be executed in whole or in part by the processor 138. Accordingly, the particular groupings illustrated in FIG. 2 are solely for the purposes of explanation of the present invention.

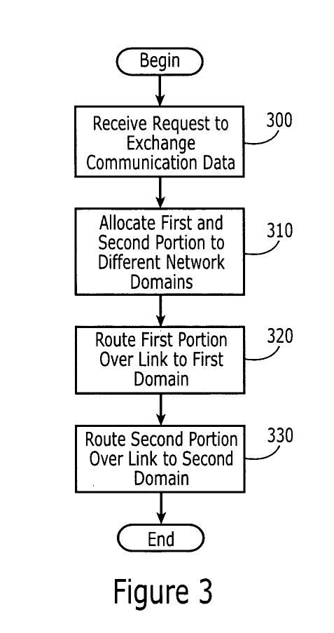

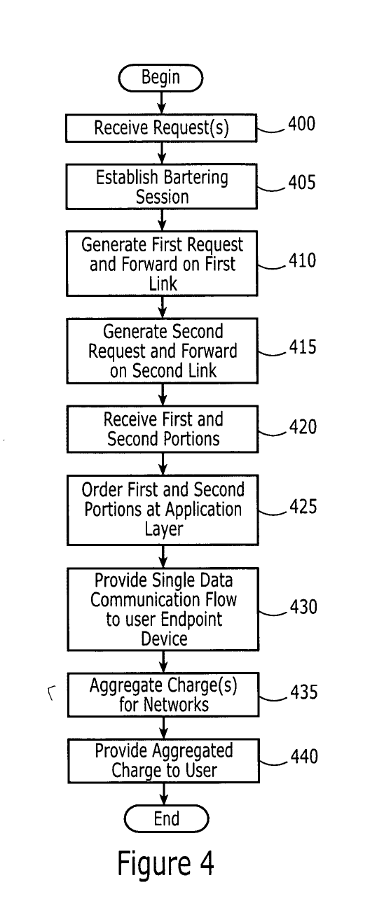

Computer implemented methods of communication load routing will now be described with reference to the flowchart illustrations of FIGS. 3-4. Referring first to the embodiments illustrated in the flowchart of FIG. 3, operations begin with receipt of request to exchange communication data between a user endpoint device and a target device (Block 300). Note that requests may be received from different endpoint devices and a plurality of requests may be received from one or more devices over time. The communication data associated with one or more of the requests may be routed over a plurality of different network domains or a single network and may, for different ones of the requests, be allocated on a different percentage basis across different networks.

At an application layer of a communication protocol, a first portion of the communication data associated with received request is allocated at the application layer for routing over a first network domain associated with a first network (Block 310). A second portion of the communication data associated with the request is allocated for routing over a second network domain associated with a second communication network. The second domain and network are administered independently from the first domain and network.

Operations in allocating the portion across the different domains at Block 310, in some embodiments, include selecting the first portion and the second portion to increase the security level associated with the transmission of the communication data. In further embodiments, operations at Block 310 include selecting the first portion and the second portion based on a cost associated with the transmission of the communication data over the first network domain and over the second network domain.

The first portion is routed between the user endpoint device and the target device over a network access link coupled to the first network domain without notifying the first network domain of the allocation of the communication data (Block 320). The second portion is routed between the user endpoint device and the target device over a network access point coupled to the second domain without notifying the second network domain of the allocation of the communication data (Block 330). The first network domain may have an associated internet protocol version different from an associated internet protocol version of the second network domain.

As discussed briefly above with reference to Block 300, in some embodiments, all of the communication data associated with the request may be routed over the link to the first domain at Block 320 or the second domain at Block 330. Thus, all of the data associated with the request may be routed over the first network domain or the second network domain. Furthermore, among a plurality requests received, each of which is associated with data, allocating operations at Block 310 may allocate a different percentage of the associated data to the first portion and the second portion for different ones of the plurality of requests.

Further embodiments of operations for load routing across a plurality of networks will now be described with reference to the flowchart illustration of FIG. 4. It will be understood that a plurality of different embodiments and operations thereof are illustrated in FIG. 4 and that different combinations of the operations at respective blocks may be included or omitted in various of the respective embodiments. For the embodiments illustrated in FIG. 4, operations begin at Block 400 by receiving communication data from the user endpoint device addressed to the target device that requests responsive communication data from the target device. In other words, for purposes of the description of FIG. 4, operations will be described with reference to a communication exchange where the initial request from the user endpoint device triggers a responsive communication of data from the target device, which responsive data is itself allocated across different networks before reassembly for delivery to the requesting user endpoint device. However, it will be understood that the present invention is not limited to load balancing in this particular context.

As shown at Block 405, before allocating portions of the communication data for routing over respective networks, a bartering session may be established between a provider of the first network domain and the provider of the second network domain for communication of the communication data. Results of the bartering for provision of the service may subsequently be used in allocating the first portion and the second portion of the data as described with reference to Block 310 of FIG. 3.

A first request is generated for the first portion of the communication data and the first request is forwarded to the target device on the network access link coupled to the first network access domain (Block 410). A second request is generated for the second portion of the communication data and the second request is forwarded to the target device on the network access link coupled to the second network access domain (Block 415). It will be understood that the operations described with reference to Block 410 and Block 415 may be included in the respective routing operations described with reference to Block 320 and 330 of FIG. 3, which may be generated responsive to allocation of the first and second portions as described herein with reference to Block 310 of FIG. 3.

The first and second portions of the communication data are received (Block 420). The first and second portions are arranged, at the application layer, to provide a single data communication data (Block 425). The arranged/assembled single data communication flow is provided to the user endpoint device (Block 430).

In some embodiments, as will be described with reference to FIG. 4 and FIG. 1, the target device 120 has an associated internet protocol (IP) address. Generating the first request at Block 410 may include setting the IP address of the target device as a destination address and a first IP address as a sender address for the first request. Operations in generating the second request at Block 415 may include setting the IP address of the target device as a destination address and a second IP address, different from the first IP address, as a sender address for the second request. In other words, for example, the communication load routing system 110a may associate a different IP address as a sender address for a request routed to the target device 120 over the network access link 126a through the first network interface 122 and a distinct IP address for the request routed through the second network interface over the network access link 126b coupled to the network domain of network B 105b.

Providing the single data communication flow 132 to the user endpoint device at Block 430 may include setting an IP address of the user endpoint device 115a as a destination address and a third address as a sender address for the single data communication flow 132. As such, the use of two different IP addresses over the links 126a, 126b may be transparent to the user endpoint device 115a. Note that, in some embodiments, the third IP address used in the transmission to the user endpoint device 115a may be the same as either the first IP address or the second IP used over the first network access link 126a or the second network access link 126b.

As also previously discussed herein, the allocation may not be exclusively through the communication load routing system 110a but may include cooperation with the second communication load routing system 110b. As such, operations for generating the second request at Block 415 may be performed in part by the second communication load routing system 110b and operations at Block 415 may include requesting generation of the second request by the second communication load routing system 110b and subsequently receiving the second portion of the communication data from the second communication load routing system 110b. Furthermore, as also shown in FIG. 1, a second user endpoint device 115b may be coupled to the second communication load routing system 110b and allocating operations described with reference to Block 310 of FIG. 3, may further include allocating at an application layer respective portions of communication data for routing between the second user endpoint device 115b and a second target device, where the second target device may be the first target device 120, over the respective network domains. In other words, both user endpoint devices 115a, 115b may utilize load balancing, which load balancing may extend across physical network access points available to the respective user endpoint devices 115a, 115b.

As further illustrated in FIG. 4, following provision of the single data communication flow to the user endpoint device, some embodiments of the present invention provide for aggregating a charge for use of the first network domain by the user endpoint device and a charge for use of the second network domain by the user endpoint device (Block 435). The aggregated charge is provided to a user of the user endpoint device (Block 440).

In the drawings and specification, there have been disclosed embodiments of the invention and, although specific terms are employed, they are used in a generic and descriptive sense only and not for purposes of limitation, the scope of the invention being set forth in the following claims.

What is claimed:

1. A method of load routing across a plurality of networks, the method comprising:
receiving a request to exchange communication data between a user endpoint device and a target device;
allocating, at an application layer, a first portion of the communication data associated with the request for routing over a first network domain and a second portion of the communication data associated with the request for routing over a second network domain, administered independently from the first network domain, to provide an allocation of the communication data;
routing the first portion between the user endpoint device and the target device over a network access link coupled to the first network domain without notifying the first network domain of the allocation of the communication data; and
routing the second portion between the user endpoint device and the target device over a network access link coupled to the second network domain without notifying the second network domain of the allocation of the communication data.

2. The method of claim 1, wherein the communication data comprises data from the target device to be routed to the user endpoint device and wherein routing the first portion and routing the second portion include:
arranging, at the application layer, the first portion and the second portion to provide a single communication data flow; and
providing the single data communication flow to the user endpoint device.

3. The method of claim 2, wherein receiving a request comprises receiving communication data from the user endpoint device addressed to the target device that requests responsive communication data from the target device and wherein routing the first portion and routing the second portion include:
generating a first request for the first portion of the communication data and forwarding the first request to the target device on the network access link coupled to the first network domain; and
generating a second request for the second portion of the communication data and forwarding the second request to the target device on the network access link coupled to the second network domain.

4. The method of claim 3, wherein the target device has an associated internet protocol (IP) address and wherein generating the first request includes setting the IP address of the target device as a destination address and a first IP address as a sender address for the first request and wherein generating the second request includes setting the IP address of the target device as a destination address and a second IP address, different from the first IP address, as a sender address for the second request and wherein providing the single data communication flow to the user endpoint device includes setting an IP address of the user endpoint device as a destination address and a third IP address as a sender address for the single data communication flow.

5. The method of claim 4, wherein the third IP address comprises the first IP address or the second IP address.

6. The method of claim 4, wherein receiving a request, allocating at an application layer, routing the first portion, routing the second portion, assembling the first portion and providing the single data flow are performed by a communication load routing system located at a user location including the user endpoint device, the communication load routing system including a first network interface to the network access link coupled to the first network domain and a second network interface to the network access link coupled to the second network domain.

7. The method of claim 4, wherein receiving a request, allocating at an application layer, routing the first portion, routing the second portion, assembling the first portion and providing the single data flow are performed by a first communication load routing system coupled to the user endpoint device and located at a user location including the user endpoint device, the first communication load routing system including a wide area network interface to the network access link coupled to the first network domain and a local network interface communicatively coupled to a second communication load routing system having a wide area network interface to the network access link coupled to the second network domain and wherein generating the first request is performed by the first communication load routing system and generating the second request is performed by the second communication load routing system and wherein the routing the second portion includes the following carried out by the first communication load routing system:
requesting generation of the second request by the second communication load routing system; and
receiving the second portion from the second communication load routing system.

8. The method of claim 7, wherein a second user endpoint device is coupled to the second communication load routing system and wherein allocating at an application layer includes allocating at an application layer a first portion of communication data for routing between the second user endpoint device and a second target device over the first network domain and a second portion of the communication data for routing between the second user endpoint device and the second target device over the second network domain.

9. The method of claim 1, wherein allocating at an application layer includes selecting the first portion and the second portion to increase a security level associated with the transmission of the communication data.

10. The method of claim 1, wherein allocating at an application layer includes selecting the first portion and the second portion based on a cost associated with the transmission of the communication data over the first network domain and over the second network domain.

11. The method of claim 1, wherein the first network domain has an associated internet protocol version different from an associated internet protocol version of the second network domain.

12. The method of claim 1, further comprising:
aggregating a charge for use of the first network domain by the user endpoint device and a charge for use of the second network domain by the user endpoint device; and
providing the aggregated charge to a user of the user endpoint device.

13. The method of claim 1, wherein allocating at an application layer includes establishing a bartering session between a provider of the first network domain and a provider of the second network domain for communication of the communication data and allocating the first portion and the second portion based on the bartering session.

14. The method of claim 1, wherein receiving a request comprises receiving a plurality of requests and wherein at least one of the plurality of requests is associated with communication data that is all routed over the first network domain or the second network domain.

15. The method of claim 1, wherein receiving a request comprises receiving a plurality of requests, each of which is associated with data and wherein allocating at an application layer includes allocating a different percentage of the associated data to the first portion and the second portion for different ones of the plurality of requests.

16. The method of claim 1, wherein the network access link coupled to the first network domain and the network access link coupled to the second network domain comprise different link types, at least one of which comprises a cable link type or a digital subscriber line (DSL) link type.

17. A communication load routing system for a user location, comprising:
a network interface to a first network having an associated first network domain;
a network interface to a second network having an associated second network domain that is administered independently from the first network domain;
an endpoint node interface coupled to a user endpoint device at the user location; and
a processor configured to allocate routing of communication data to be exchanged between the user endpoint device and a target device across both the first network domain and the second network domain at an application layer without notifying the first or second network domain of the allocation of the communication data.

18. The system of claim 17, wherein the processor is configured to associate a first internet protocol (IP) address with a portion of the communication data allocated to the first network domain and a second IP address with the communication data allocated to the second network domain and to associate a third IP address to the user endpoint device and wherein the processor is further configured to arrange communication data received from both the first and the second network domain as a single data stream to the user endpoint device at the application layer.

19. The system of claim 18, wherein the processor is further configured to receive communication data from the user endpoint device addressed to the target device that requests responsive communication data from the target device, to generate a first request for the first portion of the communication data and forward the first request to the target device on the network interface coupled to the first network and to generate a second request for the second portion of the communication data and forward the second request to the target device on the network interface coupled to the second network.

20. A computer program product for load routing across a plurality of networks, comprising:
a computer readable medium having computer readable program code embodied therein, the computer readable program code comprising:
computer readable program code configured to receive a request to exchange communication data between a user endpoint device and a target device;
computer readable program code configured to allocate, at an application layer, a first portion of the communication data for routing over a first network domain and a second portion of the communication data for routing over a second network domain, administered independently from the first network domain, to provide an allocation of the communication data;
computer readable program code configured to route the first portion between the user endpoint device and the target device over a network access link coupled to the first network domain without notifying the first network domain of the allocation of the communication data; and
computer readable program code configured to route the second portion between the user endpoint device and the target device over a network access link coupled to the second network domain without notifying the second network domain of the allocation of the communication data.
